(19) United States
(12) Patent Application Publication
(10) Pub. No.: US 2026/0138140 A1
(43) Pub. Date: May 21, 2026

(54) CHIRAL SEPARATION SYSTEMS AND METHODS

(71) Applicant: Chirality Biosciences, Inc., Farmingdale, NY (US)

(72) Inventors: Arielle H. Gabalski, Bellmore, NY (US); Donald A. Moffa, III, Wheat Ridge, CO (US)

(73) Assignee: Chirality Biosciences, Inc., Farmingdale, NY (US)

(21) Appl. No.: 19/449,271

(22) Filed: Jan. 14, 2026

Related U.S. Application Data
(63) Continuation of application No. PCT/US2024/040459, filed on Jul. 31, 2024.
(60) Provisional application No. 63/578,706, filed on Aug. 25, 2023.
(60) Provisional application No. 63/516,916, filed on Aug. 1, 2023.

(51) Int. Cl. B03C 5/02; B03C 1/24

(52) U.S. Cl. CPC B03C 5/02; B03C 1/24; B03C 2201/18

(57) ABSTRACT

Systems and methods for separating chiral objects in a mixed solution are provided. In some aspects, a method includes providing a separation device with a mixed solution of chiral objects comprising a first species of chiral objects and a second species of chiral objects. The method also includes directing an electromagnetic system positioned about the separation device to generate a time-dependent electric field excitation configured to selectively control a propulsion of chiral objects in the mixed solution to spatially separate the first species of chiral objects from the second species of chiral objects inside the separation device. The method further includes collecting spatially separated chiral objects from the separation device.

### CROSS-REFERENCE TO RELATED APPLICATIONS

This application is a continuation of PCT Application No. PCT/US24/40459, filed 31-JUL-2024, which claims priority to and the benefit of U.S. Provisional Patent Application No. 63/516,916, filed on August 1, 2023, and U.S. Provisional Patent Application No. 63/578,706, filed on August 25, 2023, each of which is incorporated by reference herein in its entirety.

### TECHNICAL FIELD

This disclosure relates generally to systems and methods for selective separation of components, and more particularly, to systems and methods for separating chiral objects in a mixed solution.

### BACKGROUND

Chirality is a characteristic of molecules or objects that exhibit differences of orientation or “handedness” (i.e., right-handed or left-handed), and can have significant effects in electromagnetic and biological systems. Hence, chiral separation can bring important benefits in many technical fields and industries, such as drug development and manufacturing, medicine, nutrition, and so forth. For instance, chiral separation may allow for reduction in side effects of medications by removing undesired components. Yet racemic solutions, which include molecules or objects with different chirality, can be difficult to separate because such molecules or objects can share physical properties, such as molecular weight, chemical composition, and charge.

Therefore, there is a need for improved technologies that can solve these and other problems.

### SUMMARY

According to aspects of the present disclosure, a system for separating chiral objects in a mixed solution is provided. The system includes a separation device configured to receive a mixed solution of chiral objects comprising a first species of chiral objects and a second species of chiral objects, and an electromagnetic system comprising a pair of parallel plates positioned about the separation device. The system also includes a controller that directs the electromagnetic system to generate a time-dependent electric field excitation using the pair of parallel conductive plates, the time-dependent electric field configured to selectively control propulsion of chiral objects in the mixed solution to spatially separate the first species of chiral objects from the second species of chiral objects inside the separation device. The system further includes a collection system in fluid communication with the separation device that is configured to collect spatially separated chiral objects from the separation device.

According to aspects of the present disclosure, a method for separating chiral objects in a mixed solution is provided. The method includes providing a separation device with a mixed solution of chiral objects comprising a first species of chiral objects and a second species of chiral objects. The method also includes directing an electromagnetic system positioned about the separation device to generate a time-dependent electric field excitation configured to selectively control a propulsion of chiral objects in the mixed solution to spatially separate the first species of chiral objects from the second species of chiral objects inside the separation device. The method further includes collecting spatially separated chiral objects from the separation device.

According to yet other aspects of the present disclosure, a system for separating chiral objects in a mixed solution is provided. The system includes a separation device with a device body forming a separation chamber configured to receive a mixed solution with a first species of chiral objects and a second species of chiral objects, and an electromagnetic system comprising a conductive wire positioned at least in part within the separation chamber. The system also includes a controller that directs the electromagnetic system to generate a time-dependent electromagnetic field excitation using the conductive wire, the time-dependent electric field configured to selectively control propulsion of chiral objects in the mixed solution to spatially separate the first species of chiral objects from the second species of chiral objects inside the separation chamber. The system further includes a collection system in fluid communication with the separation chamber that is configured to collect spatially separated chiral objects from the separation chamber.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The foregoing and other advantages of the present disclosure will become apparent upon reading the following detailed description and upon reference to the drawings.

FIG. 1 is a schematic diagram of an example system, according to aspects of the present disclosure.

FIG. 2 is a schematic diagram of an example separation apparatus, according to aspects of the present disclosure.

FIG. 3A is a perspective view of an example separation device, according to aspects of the present disclosure.

FIG. 3B is a side view of the example separation apparatus in FIG. 3A, according to aspects of the present disclosure.

FIG. 3C is a top view of the example separation apparatus in FIG. 3A, according to aspects of the present disclosure.

FIG. 4A is a perspective view of another example separation device, according to aspects of the present disclosure.

FIG. 4B is a side view of the example separation device in FIG. 4A, according to aspects of the present disclosure.

FIG. 4C is a top view of the example separation device in FIG. 4A, according to aspects of the present disclosure.

FIG. 5A is a perspective view of yet another example separation device, according to aspects of the present disclosure.

FIG. 5B is a side view of the example separation device in FIG. 5A, according to aspects of the present disclosure.

FIG. 5C is a side view of an example separation chamber used in the example separation device in FIG. 5A.

FIG. 5D is a front view of the example separation device in FIG. 5A, according to aspects of the present disclosure.

FIG. 6 is a flowchart setting forth steps of a process, according to aspects of the present disclosure.

FIG. 7A is a graph showing an example waveform, according to aspects of the present disclosure.

FIG. 7B is a graph showing another example waveform, according to aspects of the present disclosure.

FIG. 7C is a graph showing yet another example waveform, according to aspects of the present disclosure.

FIG. 7D is a graph showing yet another example waveform, according to aspects of the present disclosure.

FIG. 7E is a graph showing yet another example waveform, according to aspects of the present disclosure.

FIG. 8 is an illustration demonstrating propulsion of chiral objects, according to aspects of the present disclosure.

While the present disclosure is susceptible to various modifications and alternative forms, specific implementations have been shown by way of example in the drawings and will be described in further detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Current chiral separation techniques are limited in their capabilities. For instance, many technologies, such as high-performance liquid chromatography (HPLC) or gas chromatography (GC), can require expensive modifications and can vary based on molecules of interest. By contrast, the present disclosure provides a system and method for chiral separation that overcomes shortcomings of these and other prior technologies.

The present disclosure is described with reference to the attached figures, where like reference numerals are used throughout the figures to designate similar or equivalent elements. The figures are not drawn to scale, and are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details, or with other methods. In other instances, well-known structures or operations are not shown in detail to avoid obscuring the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

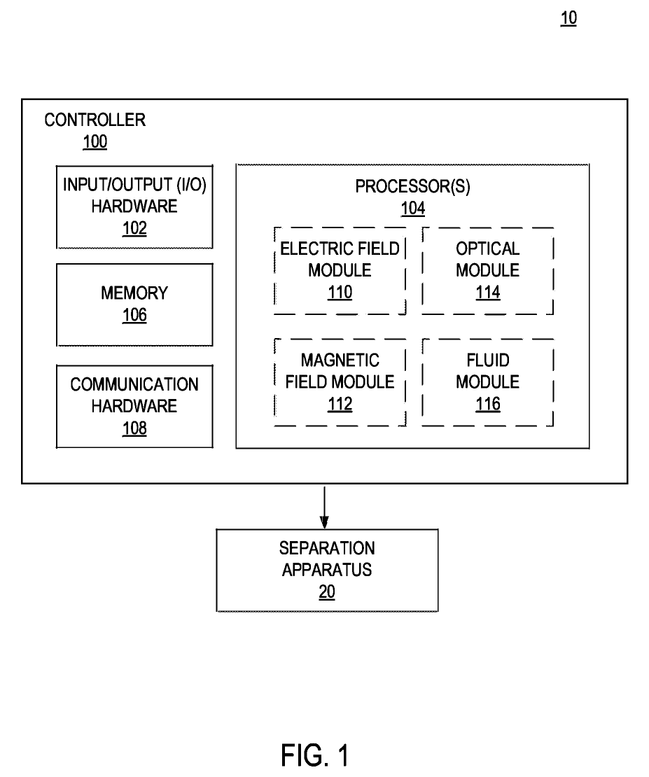

Referring particularly to FIG. 1, an example system 10 for separating chiral objects in a mixed solution or racemic solution, in accordance with aspects of the present disclosure, is illustrated. In some embodiments, the system 10 includes a controller 100, and a separation apparatus 150.

In general, the controller 100 may include any device, apparatus, system, or a combination thereof, that is configured to carry out steps in accordance with aspects of the present disclosure. For instance, the controller 100 can be implemented using a general-purpose computer or computing system, mobile device, smartphone, personal digital assistant (PDA), wearable device, tablet, workstation, server, and so forth. In some implementations, the controller 100 may include, be part of, or operate in collaboration with, various computers, systems, devices, machines, mainframes, networks, servers, databases, and so forth, to control various aspects and functions of the separation apparatus 150, as described below.

As shown in FIG. 1, in some embodiments, the controller 100 may include various input/output (I/O) hardware 102, one or more processor 104, at least one memory 106, and a communication network 108.

The I/O hardware 102 may include various input and output elements for receiving and relaying various data and information. Example input elements may include a mouse, keyboard, touchpad, touchscreen, buttons, and other user interfaces configured for receiving various selections, indications, and operational instructions from a user. Example output elements may include displays, touchscreens, speakers, LCDs, LEDs, and so forth. Input and/or output elements may also include various I/O receptacles and ports, such as flash-drive ports, USB ports, CD/DVD drives, network ports, serial ports, audio/video ports, and other receptacles for sending and/or receiving various data and information.

In some embodiments, the I/O hardware 102 may include one or more electronic device, hardware, and circuitry capable of a wide range of functionality, including generating, receiving, and/or processing various signals. For example, the signal I/O hardware 102 may include one or more voltage source, current source, signal generator, amplifier, filter, digitizers, mixer, multiplexer, voltmeter, digital/analog oscilloscope, data acquisition card, digital/analog signal controller and/or processor, modulator, demodulator, logic block, and so forth. In some implementations, the signal I/O hardware 102 may be configured to generate and output one or more control signal or waveform directing an electromagnetic system to generate and provide various electric, magnetic, and/or optical excitations, in accordance with aspects of the present disclosure.

The processor(s) 104 may be configured to carry out various functions, processing, and operations for the controller 100. In some embodiments, one or more processor 104 may include one or more programmable processor. Programmable processor(s) may be configured (e.g., programmed) to carry out steps in accordance with the present disclosure, for instance, using executable instructions stored in a non-transitory machine-readable or computer-readable medium. Additionally, or alternatively, one or more processor 104 may include one or more dedicated processing unit or module, which may be configured (e.g., hardwired using various logic/ circuitry, and so forth) to carry out steps, in accordance with aspects of the present disclosure. By way of example, the processor(s) 104 may include one or more central processing unit (CPU), graphics processing unit (GPUs), microprocessor, digital signal processor, microcontroller, application specific integrated circuit (ASIC), programmable logic device (PLD), field programmable logic device (FPLD), field programmable gate array (FPGA), and so forth.

In some implementations, the processor(s) 104 may be configured to control a separation of chiral objects in a mixed solution, in accordance with the aspects of the present disclosure. For instance, the processor(s) 104 may control generation and output of one or more control signal directing an electromagnetic system, or various hardware and/or components therein, to generate and provide various electric, magnetic, and/or optical field, in accordance with aspects of the present disclosure. For example, the processor(s) 104 may direct the I/O hardware 102 to generate and output one or more control signal or waveform directing an electromagnetic system to generate and provide various electric, magnetic, and/or optical excitations.

As mentioned, in some embodiments, the processor(s) 104 may include one or more dedicated control module. For instance, as illustrated in FIG. 1, the processor(s) 104 may include an electric field module 110, a magnetic field module 112, an optical module 114, a fluid module 116, or any combination thereof. The electric field module 110 may be configured to control an electric field excitation, such as a time-dependent or a time-independent electric field. The magnetic field module 112 may be configured to control a magnetic field excitation, such as a time-dependent or a time-independent magnetic field. The optical module 114 may be configured to control an optical excitation, such as polarized light (e.g., circularly polarized light, linearly polarized light, elliptically polarized light and so forth). The fluid field 116 may be configured to control fluid flow, such as flow of a mixed solution, or flow of a separation solution, as described herein.

In some implementations, two or more dedicated modules of the processor(s) 104 may coordinate operation. For instance, in one example, the electric field module 110 and a magnetic field module 112, may coordinate delivery of electric field and magnetic field excitation to a mixed solution. In another example, the electric field module 110 and optical module 114 may coordinate delivery of electric field and optical excitation to a mixed solution. In yet another example, the electric field module 110, the magnetic field module 112, and the optical module 114 may coordinate delivery of electric field, magnetic field, and optical excitation to a mixed solution. Coordination may be achieved by time-locking or triggering various control signal(s) or waveform(s) provided by respective dedicated modules. To achieve coordination, the two or more dedicated modules of the processor(s) 104 may communicate with one another, as well as communicate with another component, such as clock on the controller 100.

The memory 106 may include any number of memory storage device and/or units. In some embodiments, the memory 106 may include a machine-readable or computer-readable medium storing one or more sets of instructions (e.g., software) embodying any one or more of the methodologies or functions described herein. The memory 106 may include single or multiple media (e.g., a centralized or distributed database, and/or associated caches and servers) that store the one or more sets of executable instructions. In some embodiments, the memory 106 may include any medium that is capable of storing, encoding, or carrying a set of instructions for execution by a computer or machine and that cause the computer or machine to perform any one or more of the methodologies of the various implementations, or that is capable of storing, encoding, or carrying data structures utilized by or associated with such a set of instructions.

By way of example, the memory 106 may include a variety of different types of memory storage devices, such as one or more solid-state memory, optical medium, magnetic medium, random-access memory (RAM), read only memory (ROM), non-volatile (NV) memory, as well as floppy disk, hard disk, CD ROM, DVD ROM, flash, and so forth. The memory 106 may also include other readable medium that may be read from and/or written to by a magnetic, optical, or other reading and/or writing system.

Components of the controller 100 may be operatively coupled, connectable, or connected to one another as well as various systems, devices, and network, to exchange data, information, and signals, via a communication network 108, as illustrated in FIG. 1. As such, the communication network 120 may include various hardware, components, and devices capable of initiating and/or carrying wireless and/or wired communication using various communication protocols. Example communication protocols include Bluetooth, Wi-Fi, local area network (“LAN”), wide area network (“WAN”), inter-network, peer-to-peer network (e.g., ad hoc peer to-peer networks), and other protocols. To this end, the communication network 120 may include one or more bus, gateway, bridge, receiver, transmitter, transceiver, antenna, as well as other components, circuitry, and hardware to facilitate communication.

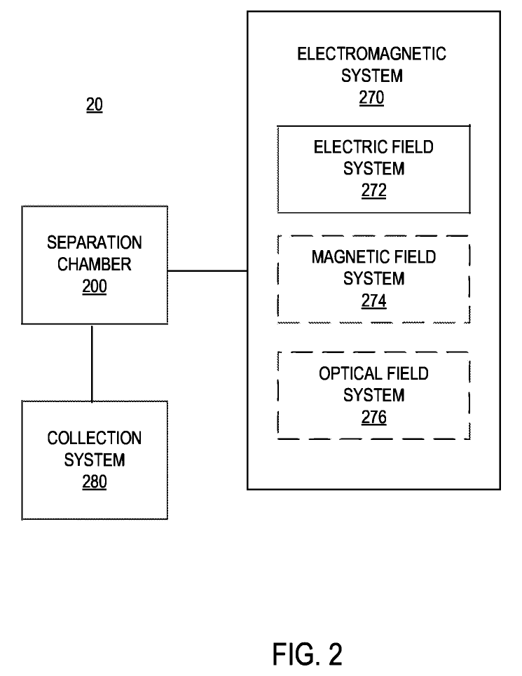

As illustrated in FIG. 1, in some embodiments, the controller 100, and/or various components therein, may be connected or connectable to a separation apparatus 20, using wired and/or wireless communication. Referring particularly to FIG. 2, the separation apparatus 20 may generally include a separation device 200 configured to receive, hold, and separate a mixed solution with chiral objects, where the mixed solution includes a first species of chiral objects or first type of enantiomer, and a second species of chiral objects or second type of enantiomer.

In particular, the separation device 200 may have any features, and shape and dimension. In one non-limiting example, the separation device 200 includes a separation chamber, such as a microfluidic separation chamber, for example. As described in further details below, the separation device 200 may include various features that facilitate chiral separation, in accordance with aspects of the present disclosure. For instance, in some embodiments, the separation chamber shaped to reduce turbulence and, in some implementations, maintain laminar flow of the mixed solution, and/or laminar flow of separated chiral species, therein. To this end, the separation chamber may include one or more internal surface that is smooth, or free of sharp corners or obstructions, to minimize or prevent fluid velocity perpendicular to flow that may cause turbulence.

In some embodiments, the separation chamber may be fluidly connected to one or more chamber inlet and/or chamber, outlet shaped and dimensioned to control direction and/or magnitude of fluid flow. In yet other embodiments, the separation chamber may include one or more barrier positioned inside the separation chamber and/or near one or more inlet and/or outlet. For instance, in one example, the barrier(s) may be in the form of a membrane, a mesh, or one or more channel, through which chiral objects may pass and be separated via molecular propulsion. In this manner, a higher degree of enantiomer separation may be achieved.

The separation apparatus 20 may also include an electromagnetic system 270, in communication with the separation device 200, that is configured to generate and provide various electric, magnetic, and/or optical excitations.

As illustrated in FIG. 2, the electromagnetic system 270 includes an electric field system 272 configured to generate and provide various electric field excitations, for instance, responsive to one or more control signal or waveform from a controller 100, as described with reference to FIG. 1. In some embodiments, the electric field system 272 includes a pair of parallel conductive plates positioned about the separation device 200 and configured to generate one or more time-dependent and/or time-independent electric field excitation. In other embodiments, the electric field system 272 includes a conductive wire positioned within the separation device 200 and configured to generate one or more time-dependent and/or time-independent electric field excitation and/or magnetic field excitation.

In some embodiments, the electromagnetic system 270 may also include a magnetic field system 274 configured to generate and provide various magnetic field excitations, for instance, responsive to one or more control signal or waveform from a controller 100, as described with reference to FIG. 1. For instance, in some embodiments, the magnetic field system 274 includes one or more magnet positioned within about and/or within the separation device configured to generate a static magnetic field. In other embodiments, the magnetic field system 274 includes one or more coil (e.g., Helmholtz coil, solenoid, and so forth.) positioned about and/or within the separation device configured to generate one or more time-dependent and/or time-independent magnetic field excitation. In yet other embodiments, the magnetic field system 274 includes an electromagnet positioned about and/or within the separation device configured to generate one or more time-dependent and/or time-independent magnetic field excitation. Applying a magnetic field excitation to a mixed solution in the separation device 200 concurrent with an electric field excitation can enhance spatial separation of chiral objects therein by increasing molecular propulsion.

In some embodiments, the electromagnetic system 270 may also include an optical field system 276 configured to generate and provide various optical field excitations, for instance, responsive to one or more control signal or waveform from a controller 100, as described with reference to FIG. 1. In some embodiments, the optical field system 276 one or more optical source positioned about and/or within the separation device configured to generate one or more time-dependent and/or time-independent optical excitation. In some implementations, the optical field system 276 is configured to generate and provide polarized light (e.g., circularly polarized light, linearly polarized light, elliptically polarized light, and so forth), by way of transmission, reflection, scattering, refraction, or a combination thereof. To this end, the optical field system 276 may include various optical elements and components, such as one or more polarizer, filter, lens, medium, mirror, and so forth. Irradiating a mixed solution in the separation device 200 with polarized light concurrent with an electric field excitation, and optionally with a magnetic field excitation, can enhance spatial separation of chiral objects therein by increasing molecular propulsion.

In some implementations, one or more electric, magnetic, and/or optical excitation generated and provided by the electromagnetic system 270, and various systems therein, may be tailored to chiral objects being received or held in the separation device 200, and/or the manner of in which the chiral objects are received or held in the separation device 200.

For instance, in some implementations, one or more electric, magnetic, and/or optical excitation may be configured to achieve and/or optimize a molecular propulsion, and hence a spatial separation, of a first species of chiral objects relative to a second species of chiral objects in a mixed solution. For example, one or more electric, magnetic, and/or optical field excitation may be configured based on one or more property of the chiral objects, such as a biological property, chemical property, and physical property (e.g., dipole moment, polarizability, density, size, symmetry, vibration mode, and so forth). The excitation(s) may also be configured based on various other conditions and parameters associated with the chiral objects and/or mixed solution, such as temperature, pressure, flow rate, and so forth. Excitation(s) may be configured by controlling or adapting one or more field parameters, such as amplitude, direction, frequency, polarization, waveform, excitation duration, and so forth, of respective excitation(s) provided by the electromagnetic system 270, and systems therein. In this manner, spatial separation of chiral objects responsive to one or more excitation(s) may be optimized.

Referring again to FIG. 2, in some embodiments, the separation apparatus 20 may also include a collection system 280 in fluid communication with the separation device 200. The collection system 280 may include various components, structures, and hardware. For instance, in some embodiments, the collection system 280 may include on or more source of fluid (e.g., mixed solution), one or more sink for fluid (e.g., first species of chiral objects, second species of chiral objects, or both), as well as various components for generating, transferring, and/or controlling fluid flow, such as one or more pump, valve, channel, filter, conduit, capillary, tubing, needle, injector, regulator, impedance, expansion, and so forth. The collection system 280, as well as various components therein, may be in fluid communication with the separation device, for instance, by virtue of one or more inlet, or inlet port, and one or more outlet, or outlet port, on the separation device 200.

In some embodiments, the collection system 280 may be configured to collect and/or store spatially separated chiral objects, such a first fluid containing predominantly a first species of chiral objects, a second fluid predominantly containing a second species of chiral objects, or both. As used herein, a fluid that “predominantly” contains a first (or second) species refers to a presence of the first (or second) species of chiral objects to be in excess, or more than 50%, in the fluid relative to the second (or first) species of chiral objects.

In addition to controlling fluid flow and/or storage of separated chiral objects, the collection system 280 may also be configured to recirculate or recycle fluid. For instance, in some implementations, the collection system 280 may recirculate fluid that predominantly contains a first species of chiral objects, or a second species of chiral objects, from one or more chamber outlet back to one or more chamber inlet. In this manner, a mixed solution may be passed through the separation device 200 multiple times, thereby iteratively increasing a ratio or excess of a first species of chiral objects relative to a second species of chiral objects, or vice versa, in a mixed solution.

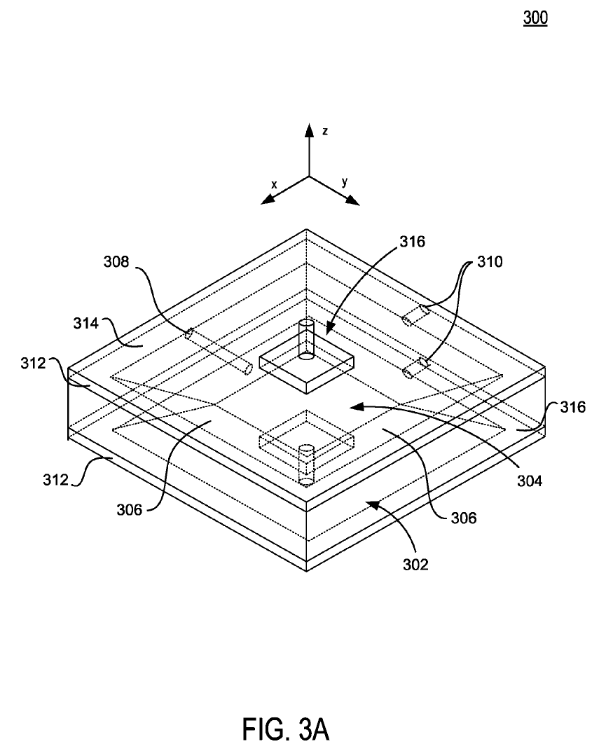

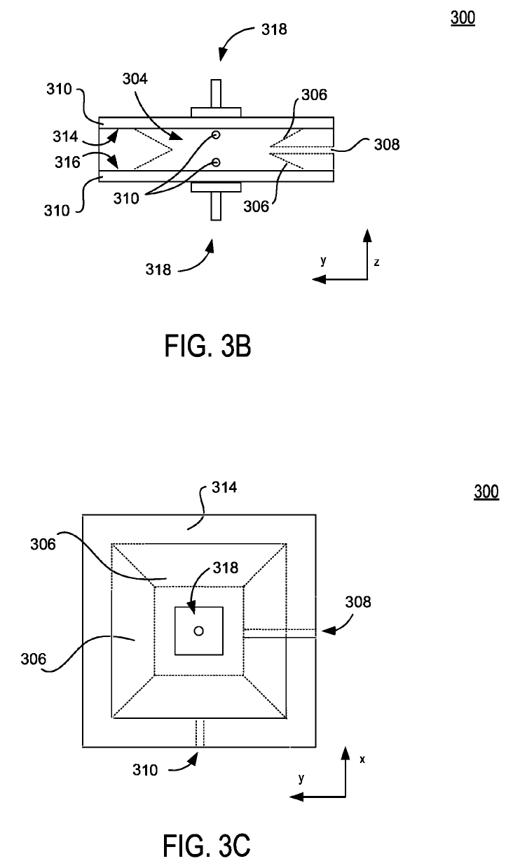

Turning now to FIGS. 3A-3C, an example separation device 300, according to aspects of the present disclosure, is illustrated. In general, the separation device 300 includes a device body 302 shaped and dimensioned to form a separation chamber 304 that can receive and/or hold a mixed solution of chiral objects.

The separation chamber 304 may have any shape and dimension. For instance, in some embodiments, the separation chamber 304 is a microfluidic separation chamber. Further, in some embodiments, the separation chamber 304 may be shaped to reduce turbulence and/or maintain laminar flow of the mixed solution, and/or laminar flow of spatially separated solutions of chiral objects, therein. To this end, the separation chamber 304 may include one or more internal surface that is smooth, or free of sharp corners or obstructions, to minimize or prevent fluid velocity perpendicular to flow that may cause turbulence. For instance, as illustrated in FIGS. 3A and 3B, the separation chamber 304 may be formed using one or more angled surfaces 306 formed in the device body 302 that can guide or enhance flow, such as flow of spatially separated solutions of chiral objects. In additional or alternatively embodiments, the separation chamber 304 may include one or more barrier and/or surface for facilitating a migration and/or aggregation of spatially separated solutions of chiral objects (not shown in FIGS. 3A-3C).

The separation chamber 304 may be fluidly connected to one or more chamber inlet 308 formed in the device body 302, which may be used supply the mixed solution to the separation chamber 304, and two or more chamber outlets 310 formed in the device body 302, which that may be used to collect spatially separated solutions of chiral objects. As illustrated, in some embodiments, the chamber inlet(s) 308 may include one or more ports connected to one or more tubes formed in the device body 302. Similarly, the chamber outlet(s) 310 may also include one or more ports connected to one or more tubes formed in the device body 302. In some embodiments, the one or more ports of the chamber inlet(s) 308 and/or chamber outlet(s) 310 may include various features for establishing a fluid communication with a collection system, for instance, as described with reference to FIG. 2. For example, ports and/or tubes of the chamber inlet(s) 308 and/or chamber outlet(s) 310 may include threads, plugs, fittings, valves, and so forth, incorporated, attached, or attachable to such ports or tubes.

As illustrated in FIGS. 3A-3C, the separation device 300 also includes a set of conductive plates 312 positioned above and below the separation chamber 302. As described, the set of conductive plates 312 may be configured to provide an electric field excitation to a mixed solution received by or held in the separation chamber 302. The conductive plates 304 may be formed using any number of conducting materials (e.g., Cu, Al, and so forth). Each conductive plate 310 may be attached or connected to the device body 302 via upper surface 314 and lower surface 316 of the device body 302.

In some embodiments, each conductive plate 312 includes a lead assembly 318 configured for making an electrical connection to wiring and/or equipment that can energize the conductive plate 312. In some embodiments, each lead assembly 318 is attached to each respective conductive plate 312, for example, via a conductive adhesive. In other embodiments, one or both lead assembly 318 is integrated into respective conducting plate 312. As illustrated in FIGS. 3A-3B, the lead assembly 318 may include a conductive plate and a conductive plug, for instance, configured to connect a clamp. Energizing either or both conductive plates 312 induces charge in the conductive plates 312 to establish an electric field in the separation chamber 304. In some implementations, either or both conductive plates 312 may be energized using a time-dependent waveform, such that a time-dependent electric field excitation is induced in the separation chamber 304 separating chiral objects in the mixed solution. Such time-dependent waveform, and hence time-dependent electric field excitation, may be periodic or aperiodic. For instance, in some non-limiting examples, the time-dependent waveform may include a saw wave, a sine wave, a ramp wave, a pulse wave, a square wave, and so forth, having one or more peak-to-peak voltage amplitude between about 1 V and about 20 V, and one or more frequency between about 20 Hz and about 20 MHz, although other amplitudes, waveforms, and frequencies may be possible. As described, in some implementations, parameters describing the time-dependent waveform may depend based on one or more property of the chiral objects in the mixed solution.

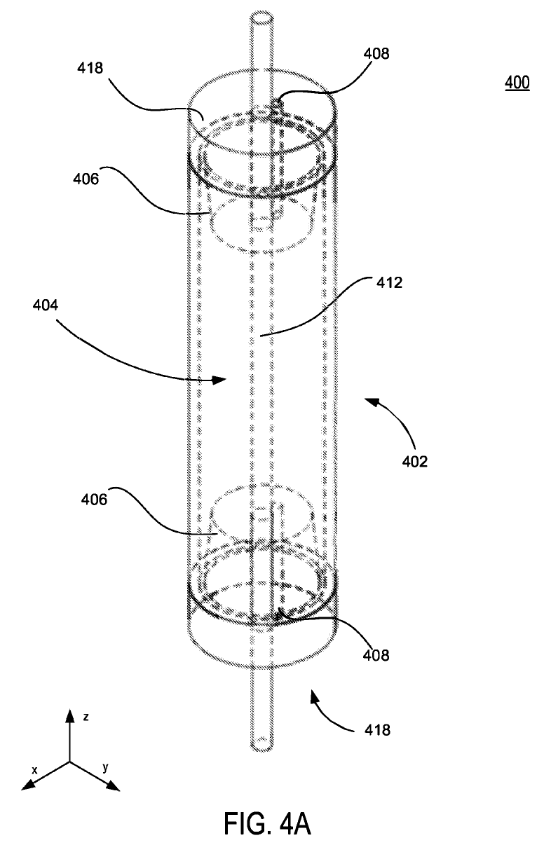

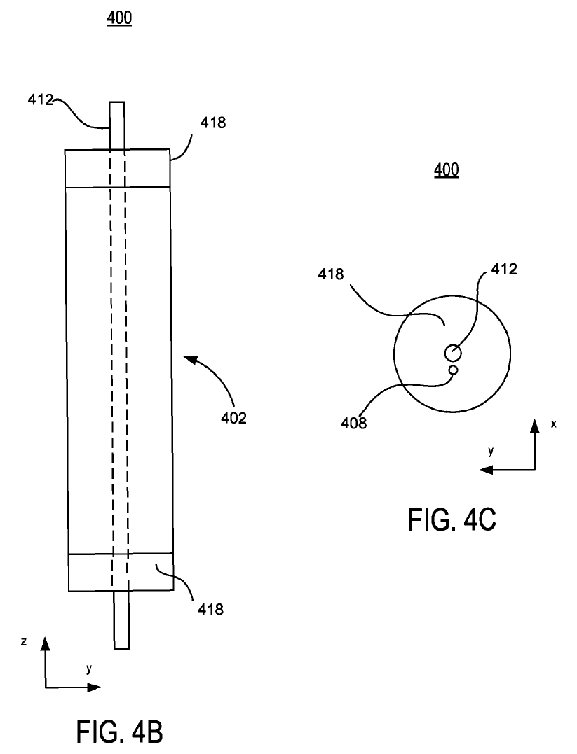

Turning now to FIGS. 4A-3C, another example separation device 400, according to aspects of the present disclosure, is illustrated. In general, the separation device 400 includes a device body 402 shaped and dimensioned to form a separation chamber 404 that can receive and/or hold a mixed solution of chiral objects.

The separation chamber 404 may have any shape and dimension. For instance, in some embodiments, the separation chamber 404 is a microfluidic separation chamber. Further, in some embodiments, the separation chamber 404 may be shaped to reduce turbulence and/or maintain laminar flow of the mixed solution, and/or laminar flow of spatially separated solutions of chiral objects, therein. To this end, the separation chamber 404 may include one or more internal surface that is smooth, or free of sharp corners or obstructions, to minimize or prevent fluid velocity perpendicular to flow that may cause turbulence. For instance, as illustrated in FIGS. 4A and 4B, the separation chamber 404 may be formed using one or more angled surfaces 406 formed in the device body 402 that can guide or enhance flow, such as flow of spatially separated solutions of chiral objects. In additional or alternatively embodiments, the separation chamber 404 may include one or more barrier and/or surface for facilitating a migration and/or aggregation of spatially separated solutions of chiral objects (not shown in FIGS. 4A-4C).

The separation chamber 404 may be fluidly connected to one or more chamber port 408 formed in the device body 402, which may be used supply a mixed solution to the separation chamber 404, as well as collect spatially separated solutions of chiral objects from the separation chamber 404. In some embodiments, the one or more ports of the chamber ports 408 may include various features for establishing a fluid communication with a collection system, for instance, as described with reference to FIG. 2. For example, one or more ports 408 may include threads, plugs, fittings, valves, and so forth, incorporated, attached, or attachable to such ports 408.

The separation device 400 also includes a conductive wire 412 positioned within the separation chamber 402. As described, the conductive wire 412 may be configured to provide an electric field excitation and/or magnetic field excitation to a mixed solution received by or held in the separation chamber 402. The conductive wire 410 may be formed using any number of conducting materials (e.g., Cu, Al, and so forth).

In some embodiments, each end of the conductive wire 412 extends through an end cap 418, which may or may not be made using a conducting material. Energizing the conductive wire 412 establishes an electric field and/or magnetic field in the separation chamber 404. In some implementations, the conductive wire 412 may be energized using a time-dependent waveform, such that a time-dependent electric field excitation and/or time-dependent magnetic field is induced in the separation chamber 404 separating chiral objects in the mixed solution. Such time-dependent waveform, and hence time-dependent electric field excitation and/or magnetic field excitation, may be periodic or aperiodic. For instance, in some non-limiting examples, the time-dependent waveform may include a saw wave, a sine wave, a ramp wave, a pulse wave, a square wave, and so forth, having one or more peak-to-peak voltage amplitude between about 1 V and about 20 V, and one or more frequency between about 20 Hz and about 20 MHz, although other amplitudes, waveforms, and frequencies may be possible. As described, in some implementations, parameters describing the time-dependent waveform may depend based on one or more property of the chiral objects in the mixed solution.

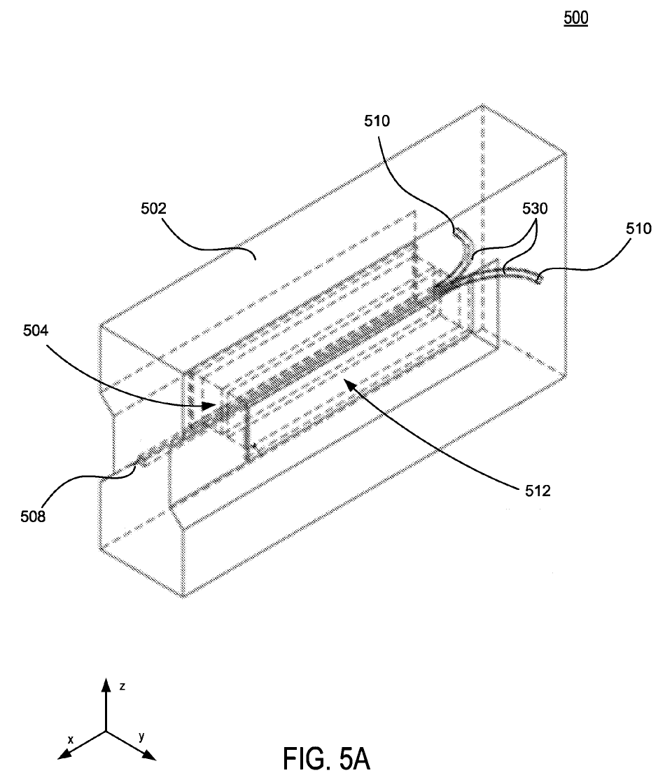

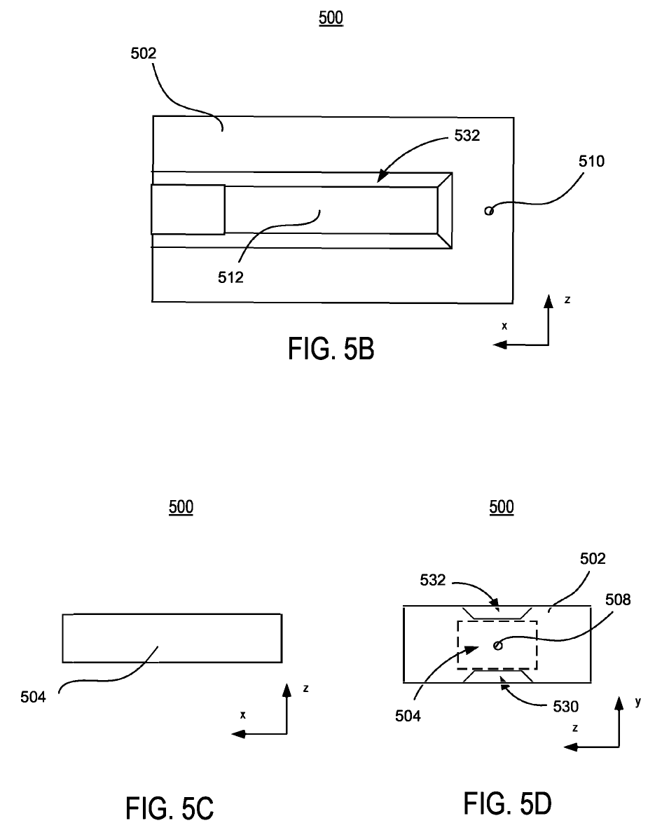

Turning now to FIGS. 5A-5C, yet another example separation device 500, according to aspects of the present disclosure, is illustrated. In general, the separation device 500 includes a device body 502 shaped and dimensioned to form a separation chamber 504 or reservoir that can receive and/or hold a mixed solution of chiral objects.

The separation chamber 504 may have any shape and dimension. For instance, in some embodiments, the separation chamber 504 is a microfluidic separation chamber. The separation chamber 504 may be fluidly connected to one or more chamber inlet 508 formed in the device body 502, which may be used supply the mixed solution to the separation chamber 304, and two or more chamber outlets 510 formed in the device body 502, which that may be used to collect spatially separated solutions of chiral objects. As illustrated, in some embodiments, the chamber inlet(s) 508 may include one or more ports connected to one or more tubes formed in the device body 502. Similarly, the chamber outlet(s) 510 may also include one or more ports connected to one or more tubes formed in the device body 502. In some embodiments, the one or more ports of the chamber inlet(s) 508 and/or chamber outlet(s) 510 may include various features for establishing a fluid communication with a collection system, for instance, as described with reference to FIG. 2. For example, ports and/or tubes of the chamber inlet(s) 508 and/or chamber outlet(s) 510 may include threads, plugs, fittings, valves, and so forth, incorporated, attached, or attachable to such ports or tubes.

Further, in some embodiments, the separation chamber 504 may be shaped to reduce turbulence and/or maintain laminar flow of the mixed solution, and/or laminar flow of spatially separated solutions of chiral objects, therein. To this end, the separation chamber 504 may include one or more internal surface that is smooth, or free of sharp corners or obstructions, to minimize or prevent fluid velocity perpendicular to flow that may cause turbulence. For instance, as illustrated in FIG. 5A, the separation chamber 504 may be connect to one or more curved extraction conduit 530 formed in the device body 502 that can guide or enhance flow, such as flow of spatially separated solutions of chiral objects. In additional or alternatively embodiments, the separation chamber 504 may include one or more barrier and/or surface for facilitating a migration and/or aggregation of spatially separated solutions of chiral objects (not shown in FIGS. 5A-5C).

As illustrated in FIGS. 5A-5C, the separation device 500 also includes a set of conductive plates 512 positioned above and below the separation chamber 302. As described, the set of conductive plates 512 may be configured to provide an electric field excitation to a mixed solution received by or held in the separation chamber 502. The conductive plates 504 may be formed using any number of conducting materials (e.g., Cu, Al, and so forth). Each conductive plate 510 may be positioned in, optionally attached to, a respective depression or slot 532 formed in the device body 502 (FIGS. 5B, 5D).

In some embodiments, each conductive plate 512 is connected to wiring and/or equipment that can energize the conductive plate 512. In some implementations, either or both conductive plates 512 may be energized using a time-dependent waveform, such that a time-dependent electric field excitation is induced in the separation chamber 504 separating chiral objects in the mixed solution. Such time-dependent waveform, and hence time-dependent electric field excitation, may be periodic or aperiodic. For instance, in some non-limiting examples, the time-dependent waveform may include a saw wave, a sine wave, a ramp wave, a pulse wave, a square wave, and so forth, having one or more peak-to-peak voltage amplitude between about 1 V and about 20 V, and one or more frequency between about 20 Hz and about 20 MHz, although other amplitudes, waveforms, and frequencies may be possible. As described, in some implementations, parameters describing the time-dependent waveform may depend based on one or more property of the chiral objects in the mixed solution.

While several example separation devices are described with respect to FIGS. 3A-5D, several modifications may be possible. For instance, in some embodiments, any of the above-described separation device may include additional inlets or ports, which may provide hydrodynamic focusing of a mixed solution introduced in respective separation chamber. Also, in some embodiments, any of the above-described separation device may include additional outlets or ports to collect, store, and/or recirculate fluid from the separation chamber. Furthermore, in some embodiments, any of the above-described separation device may include capabilities for providing magnetic field and/or optical field excitations, as described.

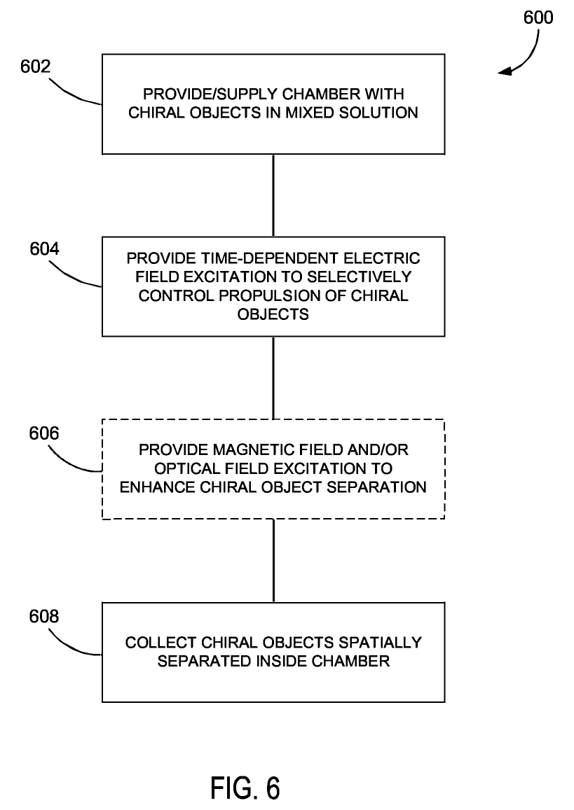

Turning now to FIG. 6, a flowchart setting forth steps of a process 600, in accordance with aspects of the present disclosure, is illustrated. Steps of the process 600 may be carried out using any combination of suitable devices or systems, such as systems and devices described herein. In some embodiments, steps of the process 600 may be implemented as instructions stored in non-transitory computer readable media, as a program, firmware or software, and executed by a general-purpose, programmed or programmable computer, processer or other computing device. In other embodiments, steps of the process 600 may be hardwired in an application-specific computer, processer, dedicated system, or module, as described with reference to FIG. 1. Although the process 600 is illustrated and described as a sequence of steps, it is contemplated that the steps may be performed in any order or combination, need not include all illustrated steps, and may include additional steps.

The process 600 may begin at process block 602 with providing and/or supplying a separation chamber of separation device with chiral objects in a mixed solution, in accordance with aspects of the present disclosure. In some implementations, providing and/or supplying the mixed solution includes filling a separation chamber with the mixed solution via one or more inlet or port connected to the separation chamber, as described. In other implementations, providing and/or supplying the mixed solution includes establishing a flow of the mixed solution, via one or more inlet or port connected to the separation chamber, as described.

A time-dependent electric field excitation may then be generated and provided to the separation chamber to selectively control propulsion of chiral objects in the mixed fluid, as indicated by process block 604. As described, this step may include directing an electromagnetic system, for instance as described with reference to FIG. 2, to generate and provide one or more electric field excitation. To this end, one or more control signal or waveform may be generated, for instance, by a controller as described with reference to FIG. 1, and output to the electromagnetic system.

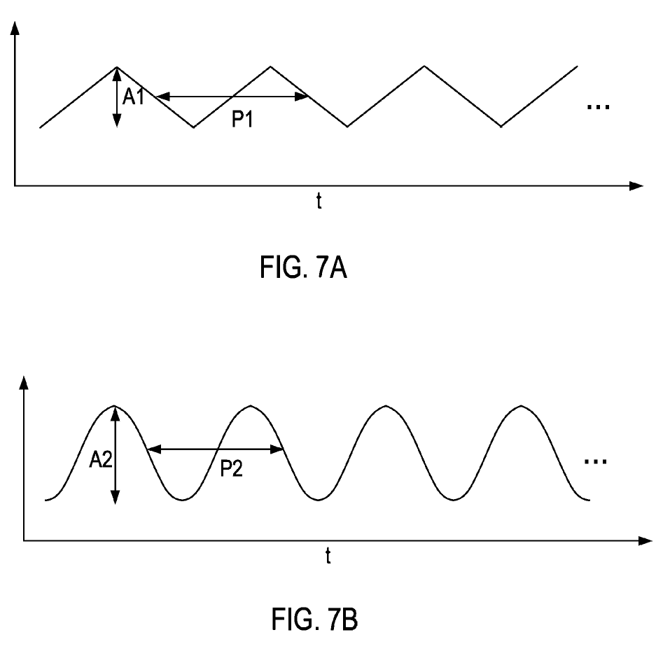

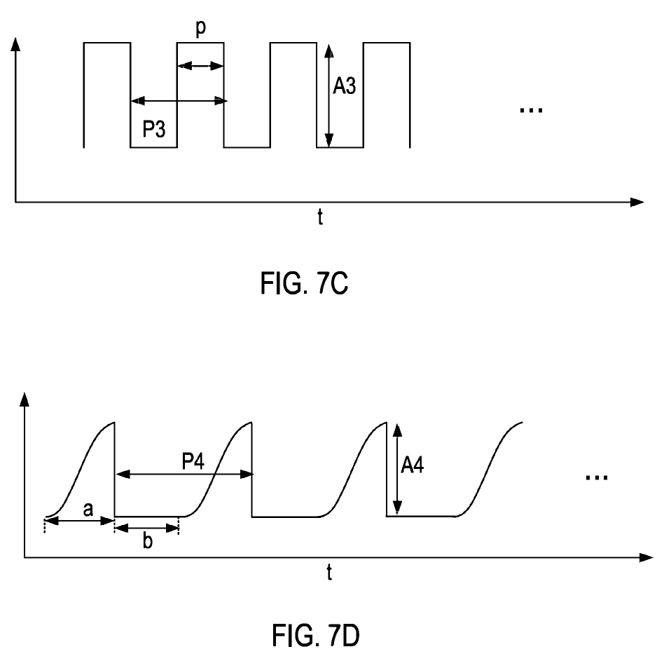

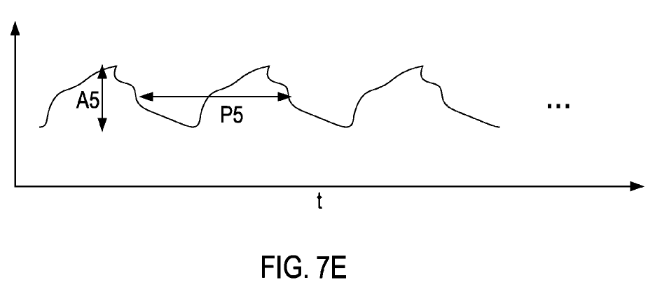

In some implementations, the time-dependent electric field excitation generated and provided at process block 604 may be periodic. Non-limiting examples of periodic excitations may include a saw wave (with amplitude A1 and period P1 in FIG. 7A), a sine wave (with amplitude A2 and period P2 in FIG. 7B), a square wave (with amplitude A3, period P3, and pulse width p in FIG. 7C), a ramp wave (with amplitude A4, period P4, ramp time a, and constant time b in FIG. 7D), an irregular wave (with amplitude A5, and period P5 in FIG. 7E) and so forth, having one or more peak-to-peak voltage amplitude between about 1 V and about 20 V, and one or more frequency between about 20 Hz and about 20 MHz, although other amplitudes, waveforms, periods, times, frequencies, and so forth, may be possible. In some implementations, parameters describing the time-dependent electric field excitation may depend based on one or more property of the chiral objects in the mixed solution. The time-dependent electric field excitation may also be additionally, or alternatively, aperiodic.

Referring again to FIG. 6, a magnetic field excitation and/or optical field excitation may be optionally generated and provided to the separation chamber to enhance chiral object separation, as indicated by process block 606. The magnetic field excitation and/or optical field excitation may be time-dependent, and/or time-independent.

As described, in some implementations, electric, magnetic, and/or optical field excitations may be configured to achieve and/or optimize a molecular propulsion, and hence a spatial separation, of a first species of chiral objects relative to a second species of chiral objects in a mixed solution. For example, one or more electric, magnetic, and/or optical field excitation may be configured based on one or more property of the chiral objects, such as a biological property, chemical property, and physical property (e.g., dipole moment, polarizability, density, size, symmetry, vibration mode, and so forth). The excitation(s) may also be configured based on various other conditions and parameters associated with the chiral objects and/or mixed solution, such as temperature, pressure, flow rate, and so forth. Excitation(s) may be configured by controlling or adapting field amplitude, direction, frequency, polarization, waveform, and so forth, of respective excitation(s) provided by the electromagnetic system. In this manner, spatial separation of chiral objects responsive to one or more excitation(s) may be optimized.

In some implementations, delivery of the electric field excitation may be coordinated with the magnetic field excitation, the optical field excitation, or both. As described, coordination may be achieved by time-locking or triggering various control signal(s) or waveform(s) provided by respective dedicated modules. To achieve coordination, the two or more dedicated modules of the processor(s) 104 may communicate with one another, as well as communicate with another component, such as clock on the controller 100.

Spatially separate chiral objects may then be collected, as indicated by process block 608. As described, this step may include directing flow of first fluid containing predominantly a first species of chiral objects, a second fluid predominantly containing a second species of chiral objects, or both, for instance, to a storage. In some implementations, flow of either species may be provided again, or multiple times, to the separation chamber, thereby iteratively increasing a ratio or excess of a first species of chiral objects relative to a second species of chiral objects, or vice versa, in a mixed solution.

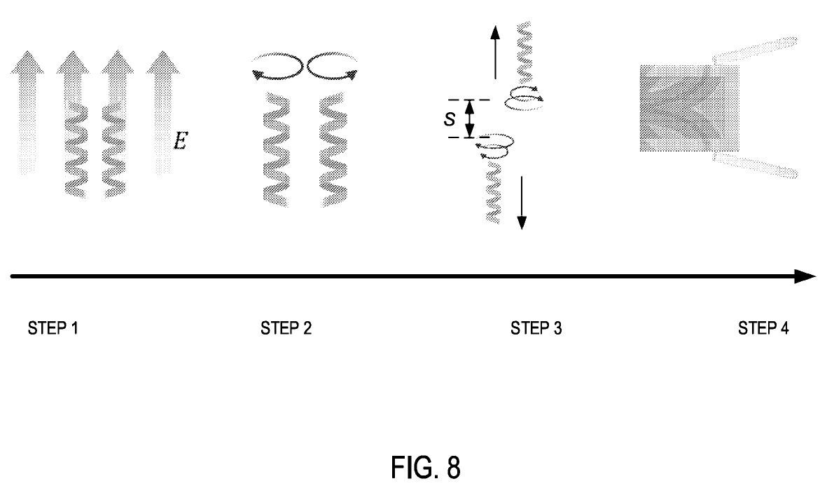

Spatial separation of chiral objects may be achieved by virtue of interaction of electric field excitation(s) with the chiral objects in the mixed solution. Referring particularly to FIG. 8, application of an electric field excitation E aligns chiral objects in the mixed solution by virtue of their dipole moments (Step 1). A molecular spin is induced in the chiral objects (Step 2). As illustrated, a first species of chiral objects rotates counterclockwise while a second species of chiral objects rotates clockwise. By virtue of opposite rotations, each species of chiral objects engages in molecular propulsion displacing respective species (e.g., vertically), but in opposite directions (Step 3), creating a spatial separation S. As may be appreciated, the special separation S may depend on a number of parameters, including parameters associated with the electric field excitation (e.g., amplitude, direction, frequency, waveform, excitation duration, and so forth), as well as properties of the chiral objects in the mixed solution. Separated species may then be collected, for instance, via separate outlets on opposite sides of a separation chamber (Step 4).

One or more elements or aspects or steps, or any portion(s) thereof, from one or more of any of the claims below can be combined with one or more elements or aspects or steps, or any portion(s) thereof, from one or more of any of the other claims or combinations thereof, to form one or more additional implementations and/or claims of the present disclosure.

While various examples of the present disclosure have been described above, such examples are presented by way of example only, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A system for separating chiral objects in a mixed solution, the system comprising:
a separation device configured to receive a mixed solution of chiral objects comprising a first species of chiral objects and a second species of chiral objects;
an electromagnetic system comprising a pair of parallel plates positioned about the separation device;
a controller that directs the electromagnetic system to generate a time-dependent electric field excitation using the pair of parallel conductive plates, the time-dependent electric field configured to selectively control propulsion of chiral objects in the mixed solution to spatially separate the first species of chiral objects from the second species of chiral objects inside the separation device; and
a collection system in fluid communication with the separation device that is configured to collect spatially separated chiral objects from the separation device.

2. The system of claim 1, wherein the separation device further comprises a device body shaped and dimensioned to form a separation chamber configured to receive the mixed solution of chiral objects.

3. The system of claim 2, wherein the separation chamber further comprises at least one chamber inlet for receiving the mixed solution, and at least one chamber outlet for providing fluid comprising the first species of chiral objects, the second species of chiral objects, or both.

4. The system of claim 2, wherein the separation chamber further comprises a first chamber outlet and a second chamber outlet a distance away from the first chamber outlet, wherein responsive to at least the time-dependent electromagnetic field excitation, fluid comprising the first species of chiral objects migrates to the first chamber outlet and fluid comprising the second specifies of chiral objects migrates to the second chamber outlet.

5. The system of claim 2, wherein the separation chamber further comprises one or more barrier separating fluid flow.

6. The system of claim 5, wherein the one or more barrier further comprises a membrane, a mesh, one or more channel, or a combination thereof.

7. The system of claim 2, wherein the device body further comprises a pair of slots formed in the device body, each slot receiving one of the parallel conductive plates.

8. The system of claim 1, wherein the electromagnetic system further comprises a magnetic field system comprising one or more coil, an electromagnet, or both, positioned about or within the separation chamber configured to generate one or more time-dependent or time-independent magnetic field excitation configured to enhance the spatial separation.

9. The system of claim 1, wherein the electromagnetic system further comprises an optical field system comprising one or more optical source positioned about or within the separation configured to generate one or more time-dependent and/or time-independent optical excitation configured to enhance the spatial separation.

10. The system of claim 1, wherein the controller is further configured to direct the electromagnetic system to generate the time-dependent electric field excitation using a saw wave, a sine wave, a square wave, a ramp wave, an irregular wave, or a combination thereof.

11. A method for separating chiral objects in a solution, the method comprising:
providing a separation device with a mixed solution of chiral objects comprising a first species of chiral objects and a second species of chiral objects;
directing an electromagnetic system positioned about the separation device to generate a time-dependent electric field excitation configured to selectively control a propulsion of chiral objects in the mixed solution to spatially separate the first species of chiral objects from the second species of chiral objects inside the separation device; and
collecting spatially separated chiral objects from the separation device.

12. The method of claim 11, wherein the method further comprises flowing the mixed solution through one or more chamber inlet connected to a separation chamber formed in the device body of the separation device.

13. The method of claim 11, wherein the method further comprises directing the electromagnetic system to generate one or more time-dependent or time-independent magnetic field excitation configured to enhance the spatial separation.

14. The method of claim 11, wherein the method further comprises directing the electromagnetic system to generate one or more time-dependent or time-independent optical excitation configured to enhance the spatial separation.

15. The method of claim 14, wherein the method further comprises generating the one or more time-dependent or time-independent optical excitation using polarized light.

16. The method of claim 11, wherein the method further comprises coordinating the time-dependent electric field excitation with a magnetic field excitation, an optical field excitation, or both.

17. A system for separating chiral objects in a mixed solution, the system comprising:
a separation device with a device body forming a separation chamber configured to receive a mixed solution with a first species of chiral objects and a second species of chiral objects;
an electromagnetic system comprising a conductive wire positioned at least in part within the separation chamber;
a controller that directs the electromagnetic system to generate a time-dependent electromagnetic field excitation using the conductive wire, the time-dependent electric field configured to selectively control propulsion of chiral objects in the mixed solution to spatially separate the first species of chiral objects from the second species of chiral objects inside the separation chamber; and
a collection system in fluid communication with the separation chamber that is configured to collect spatially separated chiral objects from the separation chamber.

18. The system of claim 17, wherein the separation chamber further comprises at least one chamber inlet for receiving the mixed solution, and at least one chamber outlet for providing fluid comprising the first species of chiral objects, the second species of chiral objects, or both.

19. The system of claim 17, wherein the separation chamber further comprises a first chamber outlet and a second chamber outlet a distance away from the first chamber outlet, wherein responsive to at least the time-dependent electromagnetic field excitation, fluid comprising the first species of chiral objects migrates to the first chamber outlet and fluid comprising the second specifies of chiral objects migrates to the second chamber outlet.

20. The system of claim 17, wherein the separation chamber further comprises one or more barrier separating fluid flow.
